(19) United States
(12) Patent Application Publication
(10) Pub. No.: US 2025/0007880 A1
(43) Pub. Date: Jan. 2, 2025

(54) Anonemis Research Software Hard Drive Protocol Policy Processes 2304

(71) Applicant: Renee Simenona Martinez, Beverly Hills, CA (US)

(72) Inventor: Renee Simenona Martinez, Beverly Hills, CA (US)

(73) Assignee: Renee Simenona Martinez, Beverly Hills, CA (US)

(21) Appl. No.: 18/217,603

(22) Filed: Jul. 2, 2023

(51) Int. Cl. H04L 9/40; H04L 41/16

(52) U.S. Cl. CPC H04L 63/02; H04L 41/16

(57) ABSTRACT

This quantum transportation management system for quantum flight management structures concerning quantum sequence triplication with quantum supremacy is an embodiment that comprises an algorithmic software process, a multioperation system, a database for quantum software processes, and a methodology that is critical verified by using Quantum Sequence Triplication.

### CROSS-REFERENCE TO RELATED APPLICATIONS

Neurological Profiles For Market Matching And Stimulus Presentation/Ser. No. 16/561,980
Pattern-based Classification/Ser. No. 16/912,009
Unusual Score Generators For A Neuro-linguistic Behavioral Recognition System/Ser. No. 17/164,210
SYSTEM AND METHOD FOR GENERATING CURATED INTERVENTIONS IN RESPONSE TO PATIENT BEHAVIOR/Ser. No. 17/213,164
Generating Ratings Predictions Using Neuro-response Data/Ser. No. 16/152,980.
System, Method, And Computer Program Product For Analog And Mix-signal Circuit Placement/Ser. No. 16/238,274.
USER BEHAVORIAL ANALYTICS FOR SECURITY ANOMALY DETECTION IN INDUSTRIAL CONTROL SYSTEMS/Ser. No. 17/442,834
Span Pointer Networks For Non-autoregressive Task-oriented Semantic Parsing For Assistant Systems Ser. No. 17/525,510
Personalized Content Delivery Using Neuro-response Priming Data/Ser. No. 16/193,930
ENHANCED RISK ASSESSMENT/Ser. No. 17/039,009
Training A Machine Learning System For ADC Compensation/Ser. No. 16/933,617.
Efficient Memory Leak Detection In Database Systems/Ser. No. 18/169,271
Sharing Probabilities For User Traits/Ser. No. 15/132,192.
Compositions And Methods For Detecting Predisposition To Cardiovascular Disease/Ser. No. 17/857,723
Medical Image Analysis Method, Medical Image Analysis Device, And Medical Image Analysis System/Ser. No. 17/515,466
Methods For Diagnosing An Autistic Spectrum Disorder/Ser. No. 16/967,361
Health And Wellness Management Technology/Ser. No. 16/891,403
Sensor Device And Methods/Ser. No. 16/471,552
Systems, Methods And Apparatuses Of Digital Assistants In An Augmented Reality Environment And Local Determination Of Virtual Object Placement And Apparatuses Of Single Or Multi-directional Lens As Portals Between A Physical World And A Digital World Component Of The Augmented Reality Environment/Ser. No. 16/853,815.
NEUROLOGICAL REHABILITATION AND TRAINING METHOD UTILIZING OCULOMOTOR, VISUAL AND/OR VESTIBULAR REHABILITATION TASKS ON SUBJECTS WITH PHARMACOLOGICALLY INDUCED NEUROPLASTICITY/Ser. No. 17/316,077
Interactive And Analytical System That Provides A Dynamic Tool For Therapies To Prevent And Cure Dementia-related Diseases/Ser. No. 17/676,562.
Molecule Counting Of Methylated Cell-free DNA For Treatment Monitoring/Ser. No. 18/187,578
Management Of Connected Sensor Devices/Ser. No. 17/390,811.
Machine Learning Model To Determine A Proper Subset Of A Multimedia File For A Viewer Based On Their Interest/Ser. No. 17/521,668
Rule Creation For Code Analysis/Ser. No. 17/850,583.
Methods, Systems, And Computer Readable Media For Suppressing Cookie Based Advertisement Retargeting/Ser. No. 15/374,653.
Technique For Alignment Of A Mobile Device Orientation Sensor With The Earth's Coordinate System/Ser. No. 16/298,410
Mapping Non-attached Subnetworks/Ser. No. 16/692,034
Batch Normalization For Replicated Layers Of Neural Network/Ser. No. 16/923,006
Error And Manipulation Resistant Search Technology/Ser. No. 16/886,986
Batch Normalization For Replicated Layers Of Neural Network/Ser. No. 16/923,006

### STATEMENT REGARDING FEDERALLY SPONSORED RESEARCH OR DEVELOPMENT

N/A

### THE NAMES OF THE PARTIES TO A JOINT RESEARCH AGREEMENT

Renee Simenona Martinez, Anonemis Research, and Scigenity Technology

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Standard Application Requirements.

### STATEMENT REGARDING PRIOR DISCLOSURES BY THE INVENTOR OR A JOINT

INVENTOR: Invention has not been disclosed.

### BACKGROUND OF THE INVENTION

### (1) Field of the Invention

The present application relates to the embodiment compromising of a software application process in quantum science regarding transportation and methodology procedure with critical outcome processes, as it relates to a specialized encrypted algorithmic database and quantum process procedure. This embodiment comprises of a search engine operated by access control tiers and segregated servers which run on frequencies for both military personnel and researchers who have been vetted with security clearances regarding various tactical areas.

### (2) Description of Related Art Including Information Disclosed Under 37 CFR 1.97 and 1.98

N/A

### BRIEF SUMMARY OF THE INVENTION

The use of traditional binary single qubit output methodology is the baseline for this operation and in the alteration regarding quantum operation. The system works by implementing artificial qubits to source and produce calculation data for equation execution. Software process with a critical interface embodiment that includes an algorithm which automatedly verifies content by cross-referencing, produces real-time content, rapid monitor, and record of transportation log which are essential elements to tactical process procedures within transportation management stated in present application of which requires a specialized database to achieve such computation.

The disclosed exemplary embodiments provide a software process procedures for such tactical purposes.

The embodiment of The Quantum Naval Management Structure which oversees the operations of Airplanes, Vehicle, Vessel, or {QNMS} is a multioperation system which runs by a quantum navigational process. Naval navigational system operations on mathematical system based on compass devices which are used for navigation and geographic orientation to determine the cardinal directions. The device can pivot to align itself with the magnetic north with the vessel automatically steering in this direction. In addition to gyroscopes and magnetometers, GPS receivers are integrated.

### BRIEF DESCRIPTION OF THE SEVERAL VIEWS OF THE DRAWING(S)

In the following detailed portion of the present description, the teachings of the present application will be explained in more detail with reference to the example embodiments shown in the drawings, in which:

FIG. 1. AR Quantum Dual Hydro-Engine System

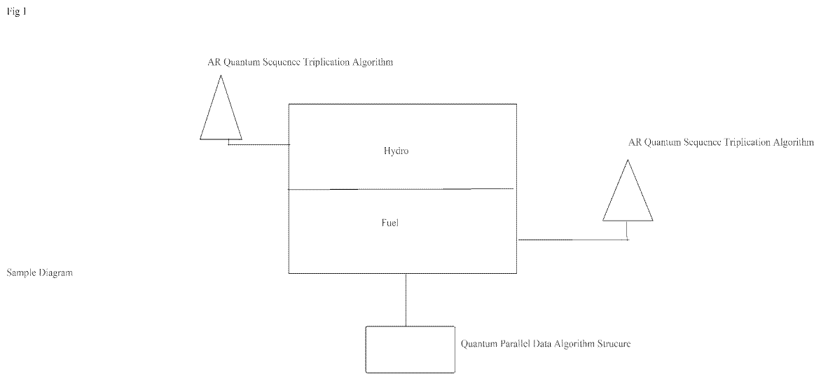

### DETAILED DESCRIPTION OF THE INVENTION

In the following detailed description, the software process according to the teachings for this application in the form of technical science will be described by the embodiments. It should be noted that the teachings of this application can also be used in any other sectors such as: telecommunications, automotives, transliteration development, chip technology, communications, data analysis, behavioral science, transportation, medicine, nuclear science, space technology, defense, quantum approximation, data algorithm structure, mechanical engineering and any software devices offering access to information.

The first embodiment comprises of a system that works by implementing a specialized rapid algorithm process which correlates data in real-time and produces predictive data which is precisely relevant to the case. The stated software process operates on a single quantum system, therefore allowing the optimal sequencing and tactical outcome. This multirole combat system is intended to perform both air superiority, strike missions, electronic warfare, intelligence, surveillance, and reconnaissance capabilities.
Quantum Fight Path Optimization During Military Operation
Quantum Rader differentiation from squadron, and enemy aircraft with weapon detection.
Quantum Automated laser detection of incoming strikes with response retaliation, and simultaneous movement diverging with automated stabilization after sequence.
Quantum Stored Flight Path and Sequence for study playback
Quantum Micro Behavioral Observation of enemy pilots to optimal strikes.
Quantum Fuel and Speed optimization.
Quantum Senar scanning for tactical terrain optimalization and reconnaissance.

The data analyzes the content from various sources to provide the user with a better advantage in any given circumstance. In Quantum Sequence Triplication, 3 qubit bits are used to achieve quantum supremacy without grey area bias. Qubit 1 and 2, are encoded using the Quantum Operation Supremacy methodology, except for the data being opposing information and data. Finally, qubit 3, is the output of the data calculation process of opposing outcomes to determine the sum data devoid of grey area but most importantly, fact checked.

The technology is intended for military strategy and defense, medicine and medical development without error, and the groundwork for quantum supremacy.

The use of traditional binary single qubit output methodology is the baseline for this operation and in the alteration regarding quantum operation. The system works by implementing artificial qubits to source and produce calculation data for equation execution. The data is stored and categorized into more ridged data columns to eliminate error and to achieve simplification. Sorting data by patterned repetitions in the level of importance relevance for desired outcome. This rapid data shuffling and detecting repetition sources regarding patterns can assist solving complex cryptology. Artificial qubits have infinite potential for quantum calculations. The use of frequency detection can detect slight use, alteration, or manipulation within the quantum monitoring system.

The operating system for the user interface includes several of the elements regarding an interactive precision experience.

The invention claimed is:

1. A software process and methodology according to claim 1, wherein compromising of a specialized encrypted an algorithmic software process, multioperation system which runs on quantum software process systems database which is critically verified through the process of Quantum Sequence Triplication resulting in Dorpman-X.I comprising of a transparent military weapon which travels on a secure network powered by frequencies, or by pre-programed Helmsman Coordinates, because of its sleek construction it's undetectable but most effectively, swift.

2. A software process and methodology according to claim 1, wherein compromising of a specialized encrypted an algorithmic software process, multioperation system which runs on quantum software process systems database which is critically verified through the process of Quantum Sequence Triplication resulting in The Helmsman Magnetic Drone Weaponry Assembly, a military grade trellis netting is dropped down from a manned or unmanned A.I. mapping helicopter or plane. Multiple quadcopters coordinate fly in programmed, preset patterns, tracing out shapes on the ground to create both a sturdy based and steel peak.

3. A software process and methodology according to claim 1, wherein compromising of a specialized encrypted an algorithmic software process, multioperation system which runs on quantum software process systems database which is critically verified through the process of Quantum Sequence Triplication resulting in The Helmsman A.1.9a Marine Precision Missile utilizes the Helmsmen Coordinates to target the precise location for hydro reaction to create a tsunami as well as seismic measurements to hit a fault line induce a reaction.

4. A software process and methodology according to claim 1, wherein compromising of a specialized encrypted an algorithmic software process, multioperation system which runs on quantum software process systems database which is critically verified through the process of Quantum Sequence Triplication resulting in The Jellyfish Decal drone is a spy drone that is constructed with a small puddy-like substance which can attach to airplanes, birds migrating to desired areas, latch onto foreign telephone lines, locations and ultimately desired targets or regions.

5. A software process and methodology according to claim 1, wherein compromising of a specialized encrypted an algorithmic software process, multioperation system which runs on quantum software process systems database which is critically verified through the process of Quantum Sequence Triplication resulting in Helmsman Submarine and Deep-Sea Research Center comprising of a craft which remains idly submerged at sea base of the United States five ocean basins: Arctic, Atlantic, Indian, Pacific, and Southern.

6. A software process and methodology according to claim 1, wherein compromising of a specialized encrypted an algorithmic software process, multioperation system which runs on quantum software process systems database which is critically verified through the process of Quantum Sequence Triplication resulting in Solar Satellite Telecommunications Network and the Solar Transportation Network with the incorporation of live digital mapping system displaying electrical, satellite, and solar power sources to established, activity, precise location in the event of an outage and potentially where a redirecting of power sourcing can be used. It is essential for cities to have a redirecting resource in place regarding its transportation, power and telecommunications networks
